(19) United States
(12) Patent Application Publication
(10) Pub. No.: US 2026/0343400 A1
(43) Pub. Date: Oct. 29, 2026

(54) UE Mobility Based on Low-Power Wake-up Signal

(71) Applicant: Apple Inc., Cupertino, CA (US)

(72) Inventors: Jie CUI, San Jose, CA (US); Yang TANG, San Jose, CA (US); Qiming LI, Beijing (CN); Dawei ZHANG, Saratoga, CA (US)

(21) Appl. No.: 19/124,363

(22) PCT Filed: Oct. 31, 2022
(86) PCT No.: PCT/CN2022/128720

§ 371 Date: Apr. 25, 2025

(51) Int. Cl. H04W 48/20; H04W 48/16; H04W 52/02; H04W 64/00

(52) U.S. Cl. CPC H04W 48/20; H04W 48/16; H04W 52/0212; H04W 64/006

(57) ABSTRACT

A user equipment (UE) is equipped with a main radio and a low-power wake-up radio (LP-WUR). The UE is configured to receive UE mobility criteria comprising one or more conditions that are to trigger a reselection from a first cell to a second cell, determine a low-power wake-up signal (LP-WUS) transmission (TX) power for the first cell, determine a LP-WUS TX power for the second cell and trigger the reselection from the first cell to the second cell based on the UE mobility criteria, the LP-WUS TX power for the first cell and the LP-WUS TX power for the second cell.

### TECHNICAL FIELD

This application relates generally to wireless communication systems, and in particular relates to UE mobility based on low-power wake-up signal.

### BACKGROUND

A user equipment (UE) may be equipped with a low-power wake-up radio (LP-WUR) and a main radio to enable wireless communication with a network. The LP-WUR may wake up or turn off the main radio of the UE in response to a low-power wake-up signal (LP-WUS) transmitted by the network. It has been identified that it may be beneficial to implement a UE mobility scheme based on LP-WUS.

### SUMMARY

Some exemplary embodiments are related to a method performed by a user equipment (UE) equipped with a main radio and a low-power wake-up radio (LP-WUR). The method includes receiving UE mobility criteria comprising one or more conditions that are to trigger a reselection from a first cell to a second cell, determining a low-power wake-up signal (LP-WUS) transmission (TX) power for the first cell, determining a LP-WUS TX power for the second cell and triggering the reselection from the first cell to the second cell based on the UE mobility criteria, the LP-WUS TX power for the first cell and the LP-WUS TX power for the second cell.

Other exemplary embodiments are related to a processor configured to receive UE mobility criteria comprising one or more conditions that are to trigger a reselection from a first cell to a second cell, determine a low-power wake-up signal (LP-WUS) transmission (TX) power for the first cell, determine a LP-WUS TX power for the second cell and trigger the reselection from the first cell to the second cell based on the UE mobility criteria, the LP-WUS TX power for the first cell and the LP-WUS TX power for the second cell.

Still further exemplary embodiments are related to a user equipment (UE) equipped with a main radio, a low-power wake-up radio (LP-WUR) and a processor configured to receive UE mobility criteria comprising one or more conditions that are to trigger a reselection from a first cell to a second cell, determine a low-power wake-up signal (LP-WUS) transmission (TX) power for the first cell, determine a LP-WUS TX power for the second cell and trigger the reselection from the first cell to the second cell based on the UE mobility criteria, the LP-WUS TX power for the first cell and the LP-WUS TX power for the second cell.

### BRIEF DESCRIPTION OF THE DRAWINGS

FIG. 1 shows an exemplary arrangement according to various exemplary embodiments.

FIG. 2 shows an exemplary user equipment (UE) according to various exemplary embodiments.

FIG. 3 shows an exemplary base station according to various exemplary embodiments.

FIG. 4a-4c show exemplary deployment scenarios according to various exemplary embodiments.

FIGS. 5a-5c each show a method for triggering UE mobility based on low-power wake-up signal (LP-WUS) according to various exemplary embodiments.

FIG. 6 shows an example abstract syntax notation one (ASN.1) for a master information block (MIB) that is configured to indicate a LP-WUS TX power parameter to be used by a cell of the network according to various exemplary embodiments.

FIG. 7 shows an example ASN.1 for a system information block (SIB) that is configured to include a neighbor cell list and corresponding LP-WUS TX power information according to various exemplary embodiments.

FIG. 8 shows an example ASN.1 for a SIB that is configured to include a LP-WUS cell pair list according to various exemplary embodiments.

FIGS. 9a-9c each show a method for triggering UE mobility based on LP-WUS according to various exemplary embodiments.

FIG. 10 shows an example ASN.1 for a SIB that is configured to include a neighbor LP-WUS coverage area list and corresponding LP-WUS TX power information according to various exemplary embodiments.

FIG. 11 shows an example ASN.1 for a SIB that is configured to include a LP-WUS cell pair list according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques configured to support the implementation of a user equipment (UE) mobility scheme based on a low-power wake-up signal (LP-WUS).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network.

However, reference to a 5G NR network is merely provided for illustrative purposes. The exemplary embodiments may be utilized with any appropriate type of network that supports UE mobility based on LP-WUS.

The UE may be equipped with a main radio and a low-power wake-up radio (LP-WUR). Throughout this description, the term “main radio” may generally refer to a legacy radio configured to enable communication with a network (e.g., 5G NR, LTE, etc.). To provide some non-limiting examples, the main radio may perform operations for radio resource management (RRM), data reception and data transmission. The term “LP-WUR” may generally refer to a radio configured to receive a wake-up signal that may trigger the main radio to wake up from a power-saving mode. Throughout this description, the wake-up signal may be referred to as a “LP-WUS.” However, any reference to the terms “LP-WUR,” “main radio” and “LP-WUS” are merely provided for illustrative purposes, different entities may refer to similar concepts by different names.

The UE may enter a power saving mode (e. g., sleep mode, low-power modes, etc.) to reduce power consumption. For example, the UE may enter a radio resource control (RRC) idle mode and refrain from exchanging signals with the network. In another example, the UE may enter RRC inactive mode and reduce communication. In other examples, the UE may implement a power saving mode in RRC connected mode such as connected discontinuous reception (C-DRX). In these examples, the UE may turn off the main radio or at least discontinue a subset of its data exchange processing functionality to conserve power. Accordingly, throughout this description, reference to a “power saving mode” may refer operation of the main radio of the UE.

The UE may use the LP-WUR to monitor for LP-WUS configured to wake up the main radio from power saving mode. This provides additional power saving benefits to the UE because it allows the UE to avoid waking up from power saving mode to perform unnecessary operations. For example, under some circumstances, the UE may wake up from RRC idle mode to receive a signal from the network, but no signal is actually transmitted by the network. To avoid this type of unnecessary power drain, a LP-WUS may be used to wake up the main radio for subsequent communication and when no LP-WUS is transmitted by the network, the UE may remain in power saving mode. However, the manner in which the power saving aspect is actually achieved is beyond the scope of the exemplary embodiments. Instead, the exemplary embodiments relate to implementing a UE mobility scheme that is adapted to LP-WUS deployment.

The exemplary embodiments introduce techniques to support the implementation of a UE mobility scheme based on LP-WUS. The exemplary techniques introduced herein may be used independently from one another, in conjunction with other currently implemented UE mobility schemes, future implementations of UE mobility schemes or independently from other UE mobility schemes.

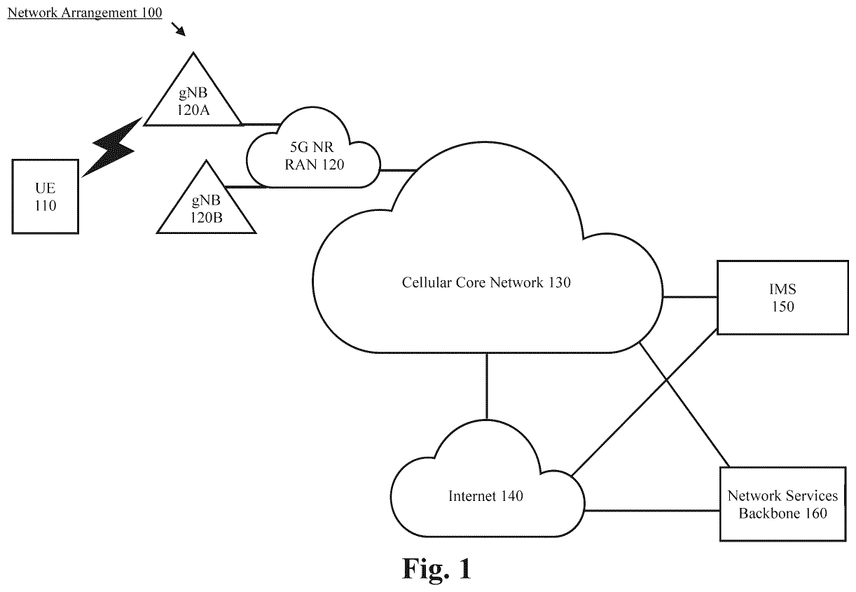

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, base stations or access nodes (Node Bs, eNodeBs, HeNBS, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as indicated above, the 5G NR RAN 120 may be associated with a particular cellular provider where the UE 110 and/or the user thereof has a contract and credential information (e.g., stored on a SIM). Upon detecting the presence of the 5G NR RAN 120, the UE 110 may transmit the corresponding credential information to associate with the 5G NR RAN 120. More specifically, the UE 110 may associate with a specific base station (e.g., gNB 120A, gNB 120B).

The exemplary embodiments relate to the transmission of LP-WUS by different cells of the network. To provide an example within the context of the network arrangement 100, gNB 120A may deploy a first cell that is configured to transmit LP-WUS and gNB 120B may deploy a second cell that is also configured to transmit LP-WUS. However, reference to a base station (e.g., gNB 120A, gNB 120B) deploying a single cell is merely provided for illustrative purposes. An actual network arrangement may include any number of base stations each deploying any number of cells.

The network arrangement 100 also includes a cellular core network 130. The cellular core network 130 may be considered as an interconnected set of components or functions that manage the operation and traffic of the cellular network. The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

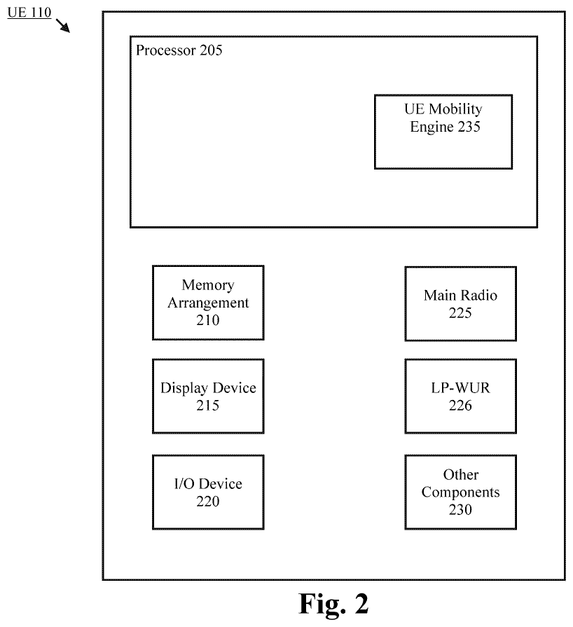

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a main radio 225, a LP-WUR 226, and other components 230. The other components 230 may include, for example, an audio input device, an audio output device, a power supply, antennas, a data acquisition device, ports to electrically connect the UE 110 to other electronic devices, etc.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The processor 205 may be configured to execute a plurality of engines of the UE 110. For example, the engines may include a UE mobility engine 235. The UE mobility engine 235 may perform various operations related to the exemplary techniques introduced herein such as, but not limited to, receiving configuration information, determining mobility criteria and triggering cell reselection.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The main radio 225 may be a hardware component (e.g., circuitry, cellular transceiver, etc.) configured to communicate with one or more networks (e.g., 5G NR-RAN 120, 6G RAN, LTE-RAN, a legacy RAN, etc.). For example, the main radio may be legacy radio to perform operations such as, but not limited to, RRM, data reception and data transmission. In some embodiments, the main radio 225 may include a cellular transceiver. In other embodiments, the main radio 225 may be communicatively coupled to a cellular transceiver.

The LP-WUR 226 may also be a hardware component configured to communicate with one or more networks. In addition, the LP-WUR 226 may be configured to wake up the main radio 225 in response to a LP-WUS. Thus, the LP-WUR 226 may be communicatively coupled to the main radio 225 and/or processor 205 to trigger the main radio 225 to wake-up from power saving mode. In some embodiments, the LP-WUR 226 and/or main radio 225 may be hard-coded or integrated with the processor 205. It should also be understood that the UE 110 may include any number of main radios and any number of LP-WURs. Thus, the example of a single main radio 225 and corresponding LP-WUR 226 is merely provided for illustrative purposes.

The LP-WUR 226 may consume less power than the main radio 225. For example, the LP-WUR 226 may have a lower data rate and operate on simple modulation schemes such as, but not limited to, on-off keying (OOK) modulation or low-level amplitude shift keying (ASK) modulation. The UE 110 may achieve power saving benefits by using the LP-WUR 226 to monitor for a wake-up signal (e.g., LP-WUS) while the main radio 225 is in power-saving mode. However, the example of power-saving operation is merely provided for illustrative purposes. The manner in which power saving is actually achieved using the main radio 225 and the LP-WUR 226 is beyond the scope of the exemplary embodiments. Instead, the exemplary embodiments introduce techniques to support the implementations of a UE mobility scheme based on LP-WUS.

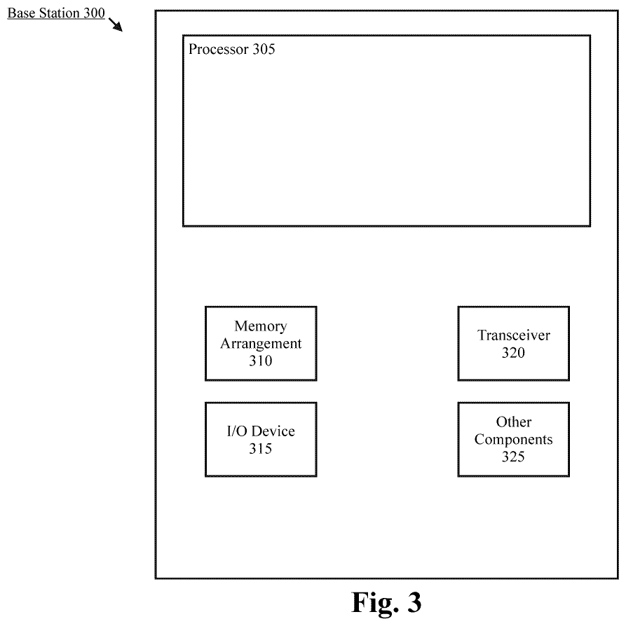

FIG. 3 shows an exemplary base station 300 according to various exemplary embodiments. The base station 300 may represent the gNB 120A, the gNB 120B and/or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, antennas, a data acquisition device and ports to electrically connect the base station 300 to other electronic devices and/or power sources.

The processor 305 may be configured to execute software for the base station 300. For example, the software may enable the base station 300 to schedule and transmit LP-WUS. The functionality associated with the software may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may be used in conjunction with one or more components (e.g., radios) to enable the data exchange with the various networks and UEs.

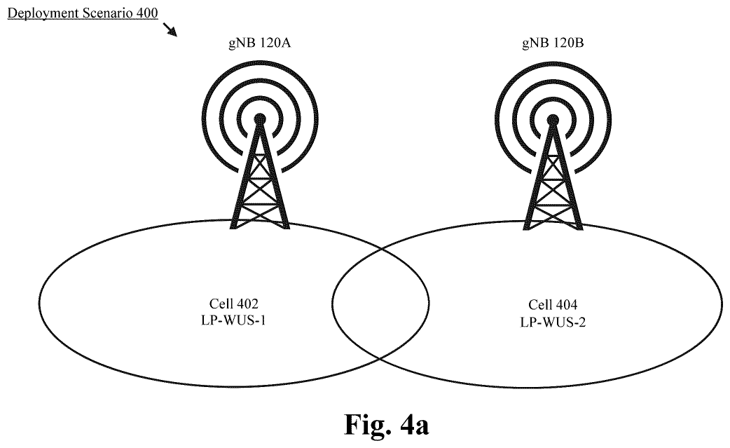

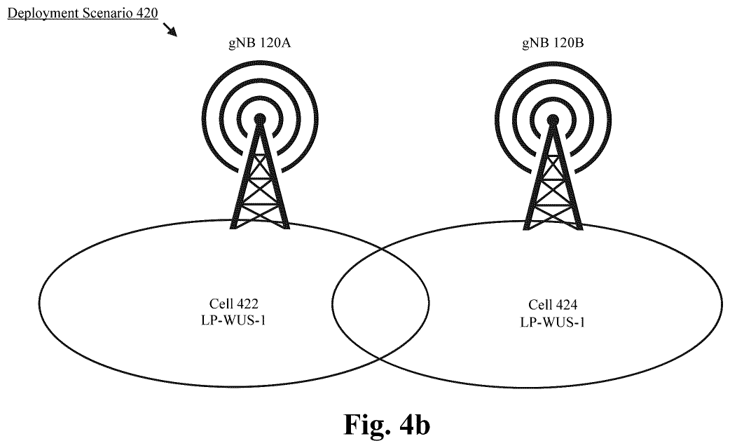

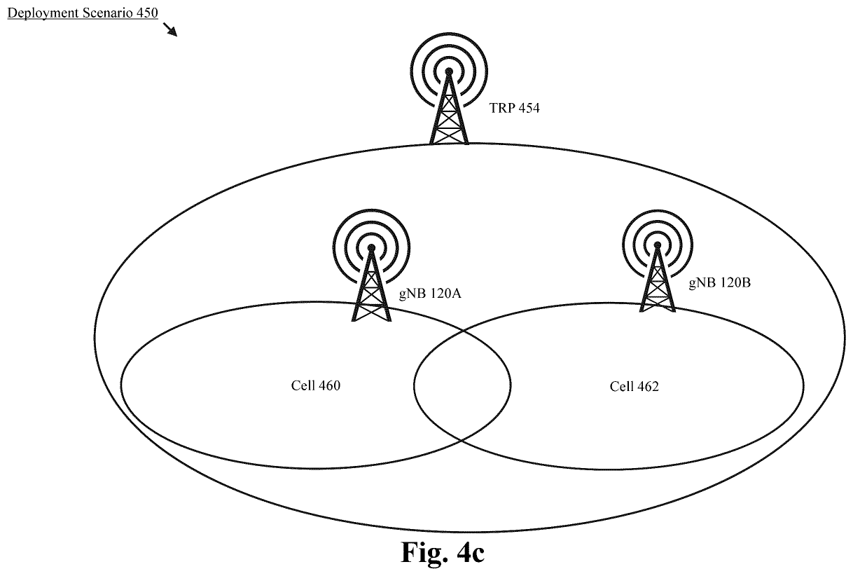

The exemplary embodiments are described with regard to three different LP-WUS deployment scenarios. A general overview of each of the exemplary deployment scenarios are provided below with regard to FIGS. 4a-4c.

FIG. 4a shows deployment scenario 400 comprising the gNB 120A and the gNB 120B. In the exemplary deployment scenario 400, different gNBs are configured to transmit different LP-WUS. Throughout this description, reference may be made to “LP-WUS-1” and “LP-WUS-2” to differentiate between different LP-WUS. However, reference to LP-WUS-1 and LP-WUS-2 is merely provided for illustrative purposes. The exemplary embodiments are not limited to this type of identifier and in an actual deployment scenario the LP-WUS may be differentiated from one another by any appropriate type of identifier or in any other appropriate manner.

In the deployment scenario 400, the gNB 120A may have a cell 402 in which the LP-WUS-1 may be transmitted and the gNB 120B may have a cell 404 in which the LP-WUS-2 may be transmitted. Thus, different gNBs may transmit different LP-WUS.

FIG. 4b shows deployment scenario 420 comprising the gNB 120A and the gNB 120B. In the exemplary deployment scenario 420, different gNBs are configured to transmit the same LP-WUS. For example, the gNB 120A may have a cell 422 in which the LP-WUS-1 may be transmitted and the gNB 120B may have a cell 424 in which the LP-WUS-1 may also be transmitted. Thus, different gNBs may transmit the same LP-WUS.

FIG. 4c shows deployment scenario 450 comprising the gNB 120A, the gNB 120B and a transmission reception point (TRP) 452. In the deployment scenario 450, the TRP 452 may provide LP-WUS coverage for multiple cells. For example, the gNB 120A may have a cell 460, the gNB 120B have a cell 462 and the TRP 452 may transmit the LP-WUS over an area that encompasses the cells deployed by the gNBs 120A, 120B. In some embodiments, the TRP 452 may operate on a dedicated frequency and/or operate as a network node dedicated to LP-WUS transmission. Although not shown in FIG. 4c, the gNBs 120A, 120B may communicate with the TRP 452 via a backhaul connection or in any other appropriate manner.

The exemplary embodiments introduce techniques to support the implementation of a UE mobility scheme based on LP-WUS. As will be described in more detail below, the LP-WUS transmission (TX) power used by a serving cell of the UE 110 and a neighbor cell of the UE 110 may provide the basis for UE mobility.

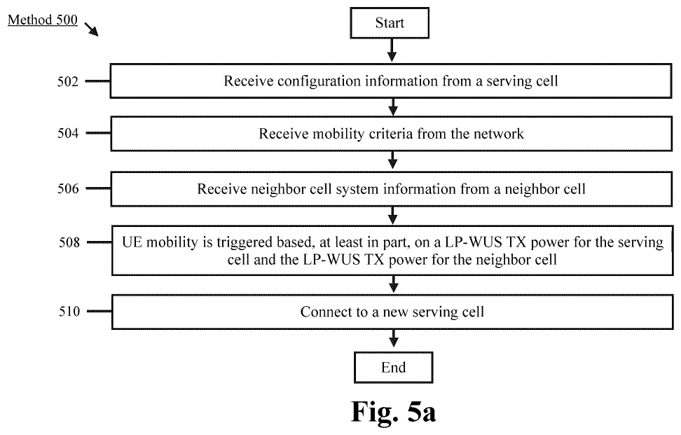

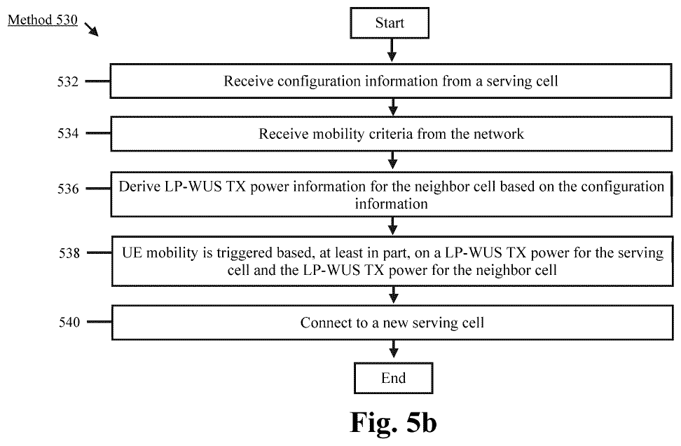

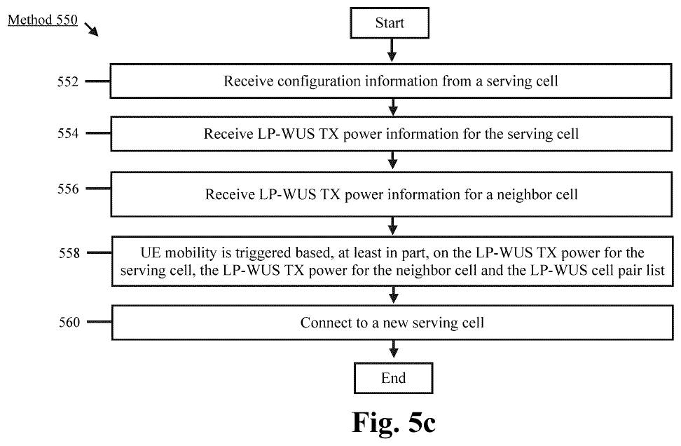

FIGS. 5a-5c each show a method for triggering UE mobility based on LP-WUS according to various exemplary embodiments. These exemplary embodiments are described within the context of the deployment scenario 400 of FIG. 4a. As mentioned above, in the deployment scenario 400, different cells 402, 404 are configured to transmit different LP-WUS (LP-WUS-1 and LP-WUS-2 respectively).

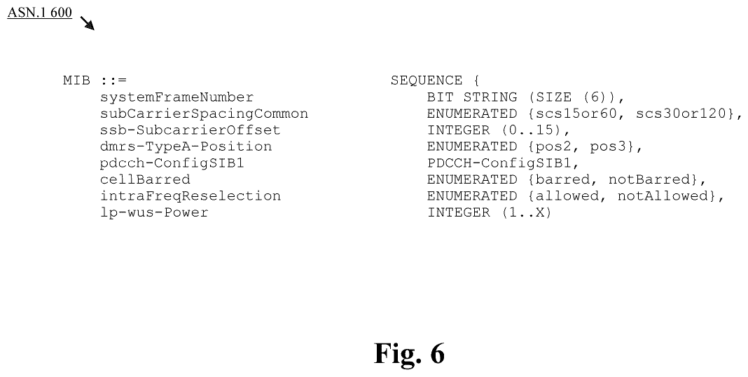

FIG. 5a shows a method 500 for triggering UE mobility based on LP-WUS according to various exemplary embodiments. In 502, the UE 110 receives configuration information from a serving cell of the UE 110. The configuration information may comprise a LP-WUS TX power parameter for the serving cell. For example, the network may provide the LP-WUS TX power information inside system information (e.g., a system information block (SIB), a master information block (MIB), etc.). In some embodiments, the LP-WUS TX power parameter may indicate an absolute value of TX power. In other embodiments, an offset value may be provided which is to be applied to a predefined nominal LP-WUS power value. An example abstract syntax notation one (ASN.1) 600 for a MIB that is configured to indicate a LP-WUS TX power parameter is provided in FIG. 6.

Returning to the method 500, in 504, the UE 110 receives mobility criteria from the network. The mobility criteria may include conditions that are to trigger UE mobility to a neighbor cell. The mobility criteria may be provided to the UE 110 in a synchronization signal block (SSB) or in any other appropriate manner. Specific examples of triggering conditions based on LP-WUS TX power will be described in more detail below.

In 506, the UE 110 receives neighbor cell system information from a neighbor cell. The neighbor cell system information may comprise at least a LP-WUS TX power parameter to be used by the neighbor cell. To provide an example within the context of the deployment scenario 400 of FIG. 4a, the cell 402 deployed by the gNB 120A may operate as a serving cell for the UE 110. For any of a variety of different reasons, the UE 110 may tune away from cell 402 and scan various frequencies to listen for signals broadcast by neighbor cells, e.g., cell 404 deployed by the gNB 120B. When tuned to the neighbor cell 404, the UE 110 may receive system information from the neighbor cell (e.g., MIB, SIB, etc.) indicating a LP-WUS TX power to be used by the neighbor cell.

In 508, UE mobility is triggered based, at least in part, on the LP-WUS TX power parameter for the serving cell and the neighbor cell. Specific examples of triggering conditions based on LP-WUS TX power will be described in more detail below. In 510, the UE 110 connects to a new serving cell. It should be understood that in an actual operating scenario, mobility may not be triggered or the mobility procedure (e. g., handover, cell reselection, etc.) towards the new serving cell may not be successful.

Returning to 504, in some embodiments, the UE mobility criteria may include a power threshold value (Z) to trigger reselection to the neighbor cell. If neighbor cell LP-WUS TX power (Y) is (Z) higher than serving cell LP-WUS TX power (X) reselection may be triggered towards the neighbor cell. In other embodiments, the UE mobility criteria may include a power offset threshold value (W). If neighbor cell LP-WUS TX power (Y) plus the power offset threshold (W) is higher than the serving cell LP-WUS TX power (X) reselection may be triggered towards the neighbor cell.

FIG. 5b shows a method 530 for triggering UE mobility based on LP-WUS according to various exemplary embodiments. In 532, the UE 110 receives configuration information from a serving cell. The configuration information may comprise a LP-WUS TX power parameter for the serving cell. The LP-WUS TX power information may be provided inside system information (e.g., SIB, MIB, etc.) or in any other appropriate manner.

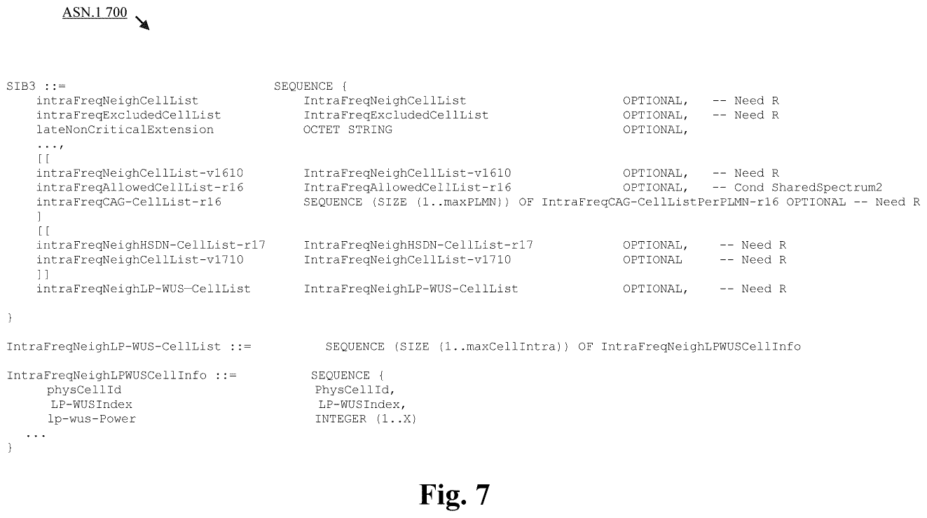

In addition, the configuration information provided by the serving cell in 532 may include a neighbor cell list with corresponding LP-WUS TX power information. An example ASN.1 700 for a SIB that is configured to include a neighbor cell list and corresponding LP-WUS TX power information is provided in FIG. 7. In this example, the neighbor cell list is identified as the parameter “IntraFreqNeighLP-WUS-CellList” comprising one or more instances of “IntraFreqNeighLPWUSCellInfo.” The IntraFreqNeighLPWUSCellInfo parameter may include a physical cell ID (physCellID) (or any other appropriate identifier), an index value for the LP-WUS (LP-WUSIndex) and a LP-WUS TX power parameter (lp-wus-power).

In 534, the UE 110 may receive mobility criteria from the network. This is similar to 504 of the method 500. In 536, the UE 110 derives LP-WUS TX power information for a neighbor cell based on the configuration information provided by the serving cell in 532, e.g., the neighbor cell list and corresponding LP-WUS TX power information. Thus, in contrast to the method 500 where the neighbor cell TX power parameter is provided to the UE 110 by the neighbor cell itself, the method 530 shows the UE 110 deriving the neighbor cell LP-WUS TX power parameter for the neighbor cell from system information provided by the serving cell.

In 538, UE mobility is triggered based, at least in part, on the LP-WUS TX power parameter for the serving cell and the neighbor cell. In 540, the UE 110 connects to a new serving cell. 538-540 are substantially similar to 508-510 of the method 500.

FIG. 5c shows a method 550 for triggering UE mobility based on LP-WUS according to various exemplary embodiments. In 552, the UE 110 receives configuration information from a serving cell. For example, the configuration information may be provided to the UE 110 via system information. As will be described in more detail below, in contrast to the methods 500-530 where mobility criteria (e.g., conditions to trigger UE mobility) was provided via SSB, the method 550 introduces a technique for providing the mobility criteria in a SIB.

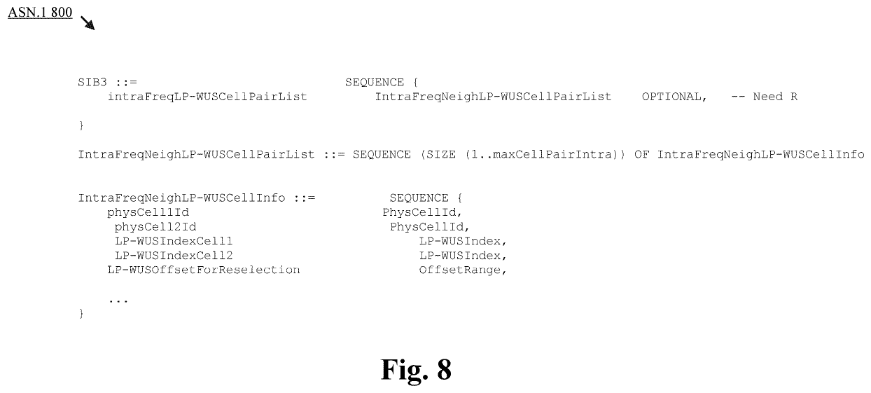

The configuration information received in 552 may include a LP-WUS cell pair list. The LP-WUS cell pair list may include one or more entries each entry comprising a first cell identifier, a second cell identifier and UE mobility criteria. For example, the configuration information may include a power offset parameter configured to trigger reselection from a first cell (“cell #1”) to a second cell (“cell #2”). An example ASN.1 800 for a SIB that is configured to include a LP-WUS cell pair list is provided in FIG. 8.

In this example, the ASN.1 800 is for a SIB3 and the LP-WUS cell pair list is represented by the parameter “IntraFreqLP-WUSCellPairList.” The parameter IntraFreqLP-WUSCellPairList includes a physical cell ID for a first cell (physcell1ID) and the physical cell ID for a second cell (physcel12ID). In addition, the parameter IntraFreqLP-WUSCellPairList includes LP-WUS index for the first cell (LP-WUSIndexCell1) and a LP-WUS index for the second cell (LP-WUSIndexCell2). The LP-WUS index may identify the different LP-WUS used by the different cells.

Further the parameter IntraFreqLP-WUSCellPairList includes a power offset value that is configured to trigger reselection (LP-WUSOffsetforReselection). In this example, the UE 110 may trigger reselection from the first cell to the second cell if the first cell LP-WUS TX power-the second cell LP-WUS TX power is greater than the power offset value. However, reference to the power offset is merely provided for illustrative purposes, the exemplary LP-WUS cell pair list may be configured to indicate any appropriate type of mobility criteria for a cell pair.

Returning to 552 of the method 550, in 554, the UE 110 receives LP-WUS TX power information for the serving cell. The LP-WUS TX power parameter for the serving cell may be provided in the same manner as described above with regard to the methods 500, 530. In 556, the UE 110 receives LP-WUS TX power information for a neighbor cell. The LP-WUS TX power parameter for the neighbor cell may be provided by the neighbor cell itself (e.g., method 500) of may be provided by the serving cell (e.g., method 530).

In 558, UE mobility is triggered based, at least in part, on the LP-WUS TX power parameter for the serving cell, the LP-WUS TX power parameter for the neighbor cell and the LP-WUS cell pair list. For example, the LP-WUS cell pair list may include an entry for the serving cell and the neighbor cell. The UE 110 may then trigger reselection from the serving cell to the neighbor cell if the serving cell LP-WUS TX power-the neighbor cell LP-WUS TX power is greater than the power offset value included in the LP-WUS cell list entry for these two particular cells. However, reference to the power offset is merely provided for illustrative purposes, the exemplary LP-WUS cell pair list may be configured to indicate any appropriate type of mobility criteria for the cell pair.

In 560, the UE 110 connects to a new serving cell.

Those skilled in the art will understand that in an actual operating scenario, mobility is not required to be triggered in 558. For example, the UE 110 may determine that the serving cell LP-WUS TX power-the neighbor cell LP-WUS TX power is not greater than the power offset value. It should also be understood that in an actual deployment scenario, the mobility procedure (e.g., handover, cell reselection, etc.) towards the new serving cell is not required to be successful.

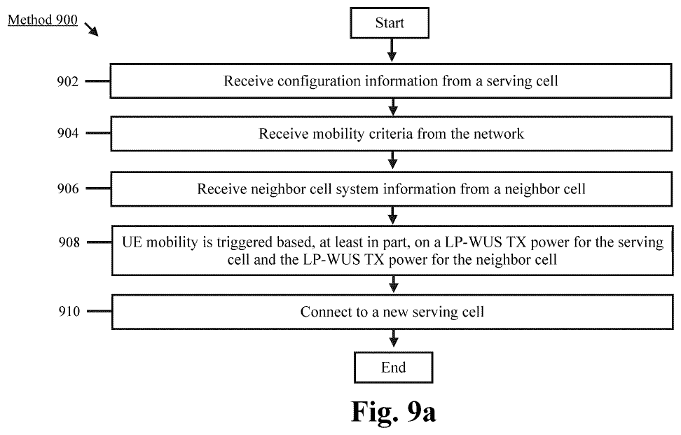

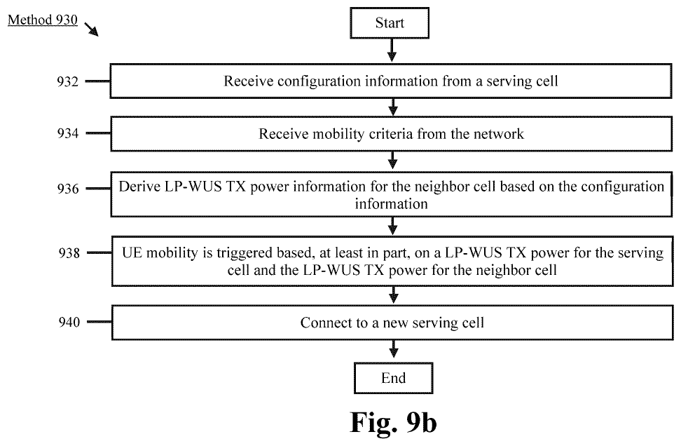

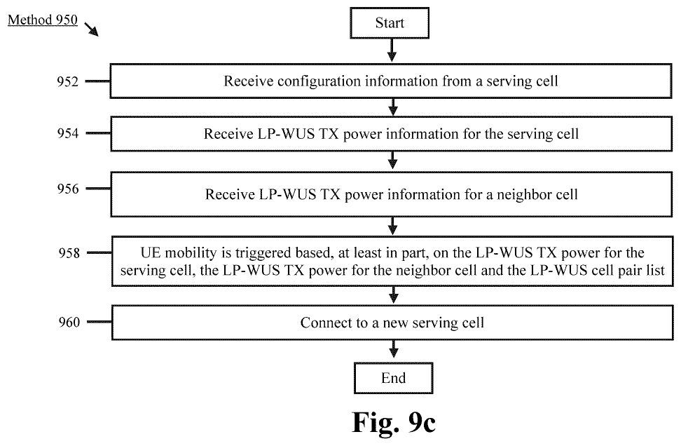

FIGS. 9a-9c each show a method for triggering UE mobility based on LP-WUS. These exemplary embodiments are described within the context of the deployment scenarios 420 of FIGS. 4b and 450 of FIG. 4c. As mentioned above, in the deployment scenario 420, different cells transmit the same LP-WUS and in deployment scenario 450, a TRP transmits LP-WUS over an area encompassing multiple cells.

FIG. 9a shows a method 900 for triggering UE mobility based on LP-WUS according to various exemplary embodiments. In 902, the UE 110 receives configuration information from a serving cell of the UE 110. The configuration information may comprise a LP-WUS TX power parameter for a LP-WUS coverage area. The method 900 is similar to the method 500 of FIG. 5a. However, in contrast to the method 500 where mobility is between legacy cells that transmit different LP-WUS, the method 900 relates to mobility towards a LP-WUS cell or LP-WUS coverage area that may encompass multiple cells that each transmit the same LP-WUS.

Throughout this description, the term LP-WUS coverage area may refer to an area over which a same LP-WUS is transmitted. For example, within the context of the deployment scenario 420, the LP-WUS coverage area may be an area that encompasses the coverage of cell 422 and cell 424. In another example, within the context of the deployment scenario 450, the LP-WUS coverage area may be the area covered by the TRP 452 which encompasses cell 460 and cell 462.

The network may provide the LP-WUS TX power information inside system information (e.g., SIB, MIB, etc.). In some embodiments, the LP-WUS TX power parameter may indicate an absolute value of TX power. In other embodiments, an offset value may be provided which is to be applied to a predefined nominal LP-WUS power value.

In 904, the UE 110 receives mobility criteria from the network. The mobility criteria may include conditions that are to trigger UE mobility to a neighbor cell. The mobility criteria may be provided to the UE 110 in a SSB or in any other appropriate manner. Specific examples of triggering conditions based on LP-WUS TX power will be described in more detail below.

In 906, the UE 110 receives neighbor cell system information from a neighbor cell. The neighbor cell system information may comprise at least a LP-WUS TX power parameter to be used by the neighbor cell.

In 908, UE mobility is triggered based, at least in part, on the LP-WUS TX power parameter for the serving cell and the neighbor cell. In some embodiments, the UE mobility criteria may include a power threshold value (Z) to trigger reselection to the neighbor cell. If neighbor cell LP-WUS TX power (Y) is (Z) higher than serving cell LP-WUS TX power (X) reselection may be triggered towards the neighbor cell. In other embodiments, the UE mobility criteria may include a power offset threshold value (W). If neighbor cell LP-WUS TX power (Y) plus the power offset threshold (W) is higher than the serving cell LP-WUS TX power (X) reselection may be triggered towards the neighbor cell. In 910, the UE 110 connects to a new serving cell.

FIG. 9b shows a method 930 for triggering UE mobility based on LP-WUS according to various exemplary embodiments. In 932, the UE 110 receives configuration information from a serving cell. The configuration information may comprise a LP-WUS TX power parameter for the serving cell. The LP-WUS TX power information may be provided inside system information (e.g., SIB, MIB, etc.) or in any other appropriate manner.

In addition, the configuration information provided by the serving cell in 932 may include a neighbor LP-WUS coverage area list with corresponding LP-WUS TX power information. The neighbor LP-WUS coverage area list may include an associated cell list for legacy cells. The associated cell list may be used for cell search when the UE wakes up to use the main radio 225 for legacy cell search. Thus, the UE 110 may only need to search the cell IDs provided in the associated cell list when the main radio 225 wakes up for cell search.

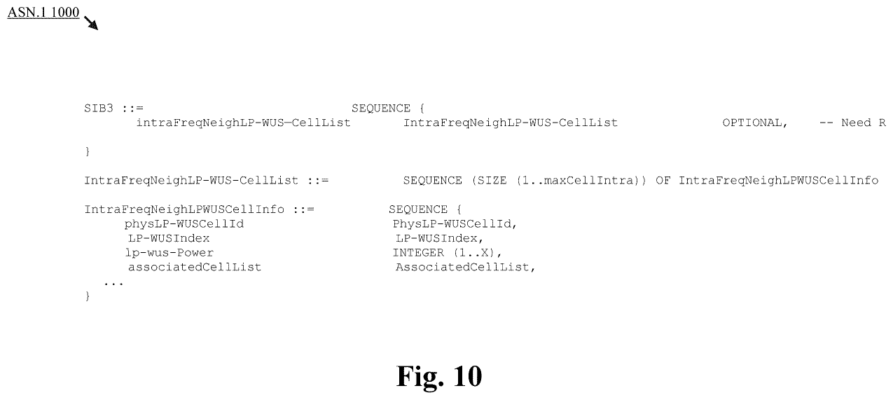

An example ASN.1 1000 for a SIB that is configured to include a neighbor LP-WUS coverage area list and corresponding LP-WUS TX power information is provided in FIG. 10. In this example, the neighbor coverage area list is identified as the parameter “IntraFreqNeighLP-WUS-CellList” comprising one or more instances of “IntraFreqNeighLPWUSCellInfo.” The IntraFreqNeighLPWUSCellInfo parameter may include a LP-WUS coverage area ID (PhysLP-WUSCellId) (or any other appropriate identifier), an index value for the LP-WUS coverage area (LP-WUSIndex), a LP-WUS TX power parameter (lp-wus-power) and an associated cell list (associatedCellList).

Returning to the method 930, in 934, the UE 110 may receive mobility criteria from the network. This is similar to 904 of the method 900. In 936, the UE 110 derives LP-WUS TX power information for a neighbor cell based on the configuration information provided by the serving cell in 532, e.g., the neighbor LP-WUS coverage area list and corresponding LP-WUS TX power information. Thus, in contrast to the method 900 where the neighbor cell TX power parameter is provided to the UE 110 by the neighbor cell itself, the method 930 shows the UE 110 deriving the neighbor cell LP-WUS TX power parameter for the neighbor cell from system information provided by the serving cell.

In 938, UE mobility is triggered based, at least in part, on the LP-WUS TX power parameter for the serving cell and the neighbor cell. In 940, the UE 110 connects to a new serving cell. 938-940 are substantially similar to 908-910 of the method 500.

FIG. 9c shows a method 950 for triggering UE mobility based on LP-WUS according to various exemplary embodiments. In 952, the UE 110 receives configuration information from a serving cell. For example, the configuration information may be provided to the UE 110 via system information. As will be described in more detail below, in contrast to the methods 900-930 where mobility criteria (e.g., conditions to trigger UE mobility) was provided via SSB, the method 950 introduces a technique for providing the mobility criteria in a SIB.

The configuration information received in 952 may include a LP-WUS cell pair list. The LP-WUS cell pair list may include one or more entries each entry comprising a first cell identifier, a second cell identifier and UE mobility criteria.

For example, the configuration information may include a power offset parameter configured to trigger reselection from a first cell (“cell #1”) to a second cell (“cell #2”). In addition, for each cell of the cell pair, a corresponding associated legacy cell list is provided that may be used for cell searching when the UE 110 wakes up the main radio 225 for legacy cell searching (e.g., the UE 110 only needs to search the Cell IDs of the associated cell list.

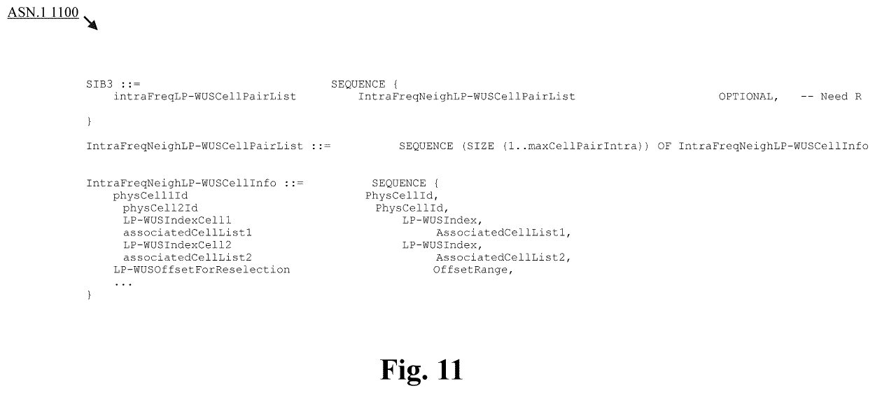

An example ASN.1 1100 for a SIB that is configured to include a LP-WUS cell pair list is provided in FIG. 11. In this example, the ASN.1 1100 is for a SIB3 and the LP-WUS cell pair list is represented by the parameter “IntraFreqLP-WUSCellPairList.” The parameter IntraFreqLP-WUSCellPairList includes a physical cell ID for a first cell (physcell1ID) and the physical cell ID for a second cell (physcell2ID). In addition, the parameter IntraFreqLP-WUSCellPairList includes LP-WUS index for the first cell (LP-WUSIndexCell1) and a LP-WUS index for the second cell (LP-WUSIndexCell2). For each cell, an associated cell list is provided (associatedCellList1 and associatedCellList2).

Further the parameter IntraFreqLP-WUSCellPairList includes a power offset value that is configured to trigger reselection (LP-WUSOffsetforReselection). In this example, the UE 110 may trigger reselection from the first cell to the second cell if the first cell LP-WUS TX power-the second cell LP-WUS TX power is greater than the power offset value. However, reference to the power offset is merely provided for illustrative purposes, the exemplary LP-WUS cell pair list may be configured to indicate any appropriate type of mobility criteria for a cell pair.

Returning to 952 of the method 950, in 954, the UE 110 receives a LP-WUS TX power parameter for the serving cell. The LP-WUS TX power parameter for the serving cell may be provided in the same manner as described above with regard to the method 900 or method 930. In 956, the UE 110 receives a LP-WUS TX power parameter for a neighbor cell. The LP-WUS TX power parameter for the neighbor cell may be provided by the neighbor cell itself (e.g., method 900) or may be provided by the serving cell (e.g., method 930).

In 958, UE mobility is triggered based, at least in part, on the LP-WUS TX power parameter for the serving cell, the LP-WUS TX power parameter for the neighbor cell and the LP-WUS cell pair list. For example, the LP-WUS cell pair list may include an entry for the serving cell and the neighbor cell. The UE 110 may then trigger reselection from the serving cell to the neighbor cell if the serving cell LP-WUS TX power-the neighbor cell LP-WUS TX power is greater than the power offset value included in the LP-WUS cell pair list entry for these two particular cells. However, reference to the power offset is merely provided for illustrative purposes, the exemplary LP-WUS cell pair list may be configured to indicate any appropriate type of mobility criteria for the cell pair.

In 960, the UE 110 connects to a new serving cell. Those skilled in the art will understand that in an actual operating scenario, mobility is not required to be triggered in 958. For example, the UE 110 may determine that the serving cell LP-WUS TX power-the neighbor cell LP-WUS TX power is not greater than the power offset value. It should also be understood that in an actual deployment scenario, the mobility procedure (e.g., handover, cell reselection, etc.) towards the new serving cell is not required to be successful.

### EXAMPLES

In a first example, a processor is configured to receive UE mobility criteria comprising one or more conditions that are to trigger a reselection from a first cell to a second cell, determine a low-power wake-up signal (LP-WUS) transmission (TX) power for the first cell, determine a LP-WUS TX power for the second cell and trigger the reselection from the first cell to the second cell based on the UE mobility criteria, the LP-WUS TX power for the first cell and the LP-WUS TX power for the second cell.

In a second example, the processor of the first example, wherein the second cell is one of multiple cells that are configured to transmit a same LP-WUS.

In a third example, the processor of the second example, wherein the second cell is one of multiple cells that are within a coverage area over which a transmission reception point (TRP) is configured to transmit LP-WUS.

In a fourth example, the processor of the third example, wherein the TRP is configured to transmit the LP-WUS over a dedicated frequency.

In a fifth example, the processor of the first example, wherein the LP-WUS TX power for the first cell is provided to the UE by a serving cell via system information.

In a sixth example, the processor of the first example, wherein the UE mobility criteria is provided to the UE by a serving cell via a system information block (SIB).

In a seventh example, the processor of the first example, wherein the LP-WUS TX power for the second cell is provided to the UE by a neighbor cell via system information.

In an eighth example, the processor of the first example, wherein the LP-WUS TX power for the second cell is provided to the UE by a serving cell via system information block (SIB).

In a ninth example, the processor of the eighth example, wherein the system information includes a neighbor LP-WUS coverage area list comprising one or more entries and wherein each entry includes at least a LP-WUS coverage area ID and a corresponding LP-WUS TX power.

In a tenth example, the processor of the ninth example, wherein each entry further comprises an associated cell list comprising a list of cells to be used for a cell search to be performed by a main radio of the UE.

In an eleventh example, the processor of the first example, wherein the mobility criteria is provided to the UE via a system information block (SIB).

In a twelfth example, the processor of the eleventh example, wherein the SIB further comprises a LP-WUS coverage area pair list comprising one or more entries and wherein each entry includes at least a first coverage area ID, a second coverage area ID and an offset power parameter that is to be used to determine whether UE mobility is to be performed from the first coverage area ID to the second coverage area ID.

In a thirteenth example, the processor of the first example, wherein the first cell and the second cell are configured to transmit different LP-WUS.

In a fourteenth example, the processor of the thirteenth example, wherein the LP-WUS TX power for the first cell is provided to the UE by a serving cell via system information.

In a fifteenth example, the processor of the thirteenth example, wherein the UE mobility criteria is provided to the UE by a serving cell via a system information block (SIB).

In a sixteenth example, the processor of the thirteenth example, wherein the LP-WUS TX power for the second cell is provided to the UE by a neighbor cell via system information.

In a seventeenth example, the processor of the thirteenth example, wherein the LP-WUS TX power for the second cell is provided to the UE by a serving cell via system information.

In an eighteenth example, the processor of the seventeenth example, wherein the system information includes a neighbor cell list comprising one or more entries and wherein each entry includes at least a physical cell ID and a corresponding LP-WUS TX power.

In a nineteenth example, the processor of the thirteenth example, wherein the mobility criteria is provided to the UE via a system information block (SIB).

In a twentieth example, the processor of the nineteenth example, wherein the SIB further comprises a LP-WUS cell pair list comprising one or more entries and wherein each entry includes at least a first cell ID, a second cell ID and an offset power parameter that is to be used to determine whether UE mobility is to be performed from the first cell ID to the second cell ID.

In a twenty first example, a user equipment (UE) comprising a main radio, a low-power wake-up radio (LP-WUR) and any of the processors of the first through twentieth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method, comprising:
at a user equipment (UE) equipped with a main radio and a low-power wake-up radio (LP-WUR):
receiving UE mobility criteria comprising one or more conditions that are to trigger a reselection from a first cell to a second cell;
determining a low-power wake-up signal (LP-WUS) transmission (TX) power for the first cell;
determining a LP-WUS TX power for the second cell; and
triggering the reselection from the first cell to the second cell based on the UE mobility criteria, the LP-WUS TX power for the first cell and the LP-WUS TX power for the second cell.

2. The method of claim 1, wherein the second cell is one of multiple cells that are configured to transmit a same LP-WUS.

3. The method of claim 2, wherein the second cell is one of multiple cells that are within a coverage area over which a transmission reception point (TRP) is configured to transmit LP-WUS.

4. The method of claim 3, wherein the TRP is configured to transmit the LP-WUS over a dedicated frequency.

5. The method of claim 1, wherein the LP-WUS TX power for the first cell is provided to the UE by a serving cell via system information.

6. The method of claim 1, wherein the UE mobility criteria is provided to the UE by a serving cell via a system information block (SIB).

7. The method of claim 1, wherein the LP-WUS TX power for the second cell is provided to the UE by a neighbor cell via system information.

8. The method of claim 1, wherein the LP-WUS TX power for the second cell is provided to the UE by a serving cell via system information block (SIB).

9. The method of claim 8, wherein the SIB includes a neighbor LP-WUS coverage area list comprising one or more entries and wherein each entry includes at least a LP-WUS coverage area ID and a corresponding LP-WUS TX power.

10. The method of claim 9, wherein each entry further comprises an associated cell list comprising a list of cells to be used for a cell search to be performed by the main radio of the UE.

11. The method of claim 1, wherein the UE mobility criteria is provided to the UE via a system information block (SIB).

12. The method of claim 11, wherein the SIB further comprises a LP-WUS coverage area pair list comprising one or more entries and wherein each entry includes at least a first coverage area ID, a second coverage area ID and an offset power parameter that is to be used to determine whether UE mobility is to be performed from the first coverage area ID to the second coverage area ID.

13. The method of claim 1, wherein the first cell and the second cell are configured to transmit different LP-WUS.

14. The method of claim 13, wherein the LP-WUS TX power for the first cell is provided to the UE by a serving cell via system information.

15. The method of claim 13, wherein the UE mobility criteria is provided to the UE by a serving cell via a system information block (SIB).

16. The method of claim 13, wherein the LP-WUS TX power for the second cell is provided to the UE by a neighbor cell via a system information block (SIB).

17. The method of claim 13, wherein the LP-WUS TX power for the second cell is provided to the UE by a serving cell via a system information block (SIB).

18. The method of claim 17, wherein the system information includes a neighbor cell list comprising one or more entries and wherein each entry includes at least a physical cell ID and a corresponding LP-WUS TX power.

19. The method of claim 13, wherein the UE mobility criteria is provided to the UE via a system information block (SIB).

20. The method of claim 19, wherein the SIB further comprises a LP-WUS cell pair list comprising one or more entries and wherein each entry includes at least a first cell ID, a second cell ID and an offset power parameter that is to be used to determine whether UE mobility is to be performed from the first cell ID to the second cell ID.
